(19) United States
(12) Patent Application Publication
(10) Pub. No.: US 2026/0211732 A1
(43) Pub. Date: Jul. 23, 2026

(54) DATA CENTER METRIC-BASED ALLOCATION OF FABRIC-ATTACHED RESOURCES

(71) Applicant: Hewlett Packard Enterprise Development LP, Spring, TX (US)

(72) Inventors: Venkatesh Nagaraj, Bangalore (IN); Debdipta Ghosh, Bangalore (IN); Derek S. Schumacher, Auburn, IL (US)

(21) Appl. No.: 19/079,734

(22) Filed: Mar. 14, 2025

(30) Foreign Application Priority Data
Jan. 22, 2025 (IN) 202511005284

(51) Int. Cl. G06F 9/50

(52) U.S. Cl. CPC G06F 9/5027

(57) ABSTRACT

A technique includes selecting paths of an interconnection fabric of a data center based on respective metric values that are associated with the paths. Each path extends from an associated host of the data center to an associated fabric-attached resource of the data center. The technique includes providing, to a fabric manager of the data center, a data structure that includes data representing the paths and the associated respective metric values. The technique includes receiving, by the fabric manger, a resource sharing request. The resource sharing request is associated with given hosts of the data center. The technique includes, responsive to the resource sharing request and based on the data structure, allocating a given fabric-attached resource to be shared by the given hosts.

### BACKGROUND

A server is a computer that provides, or serves, information to other computers (called "clients") for any of a number of different purposes. In examples, a server may execute monolithic applications, host microservices, provide data storage services, perform parallel processing tasks, or provide other functions or services.

A large number (e.g., thousands) of servers may be located in a data center. A data center provides infrastructures (e.g., an electrical power distribution infrastructure, a networking infrastructure, and a cooling infrastructure) to support the servers.

### BRIEF DESCRIPTION OF THE DRAWINGS

FIG. 1 is a block diagram of a computer network having a data center with an architecture that allows fabric-attached resources to be allocated for hosts based on data center metric values, according to an example implementation.

FIG. 2 is a block diagram of a data center metric-based resource composition engine according to an example implementation.

FIG. 3 is a block diagram of a data center illustrating components of an interconnection fabric for connecting fabric-attached resource devices to hosts, according to an example implementation.

FIG. 4 is an illustration of a latency table generated by a data center metric-based resource composition engine according to an example implementation.

FIG. 5 is a bipartite graph used by a distributed fabric manager engine to allocate fabric-attached resource devices for hosts, according to an example implementation.

FIGS. 6A and 6B are bipartite graphs depicting a fabric manager engine's consideration of a bipartite matching property when allocating fabric-attached resources for hosts, according to an example implementation.

FIG. 7 is a flow diagram depicting a technique to generate a bipartite graph and a corresponding bipartite graph data structure according to an example implementation.

FIG. 8 is a flow diagram depicting a technique to update a bipartite graph and a corresponding bipartite graph data according to an example implementation.

FIG. 9 is a flow diagram depicting a technique to process a resource sharing allocation request according to an example implementation.

FIG. 10 is a flow diagram depicting a technique to allocate a fabric-attached resource based on data center metric values, according to an example implementation.

FIG. 11 is an illustration of a non-transitory storage medium that stores instructions that, when executed by a hardware processor, cause a fabric manager to process a resource sharing request using a bipartite graph, according to an example implementation.

FIG. 12 is a block diagram of a data center having a fabric manager engine that processes a resource sharing request using a bipartite graph, according to an example implementation.

### DETAILED DESCRIPTION

A server has associated resources that support the execution of application workloads. In examples, the resources include central processing unit (CPU) cores, graphics processing unit (GPU) cores and memory. Some of the resources may be on-board, or local, to the server. In an example, dual inline memory modules (DIMMs) that are installed in memory slots of a server's motherboard provide local memory. In another example, CPU semiconductor packages that are installed in CPU sockets of the motherboard provide local CPU cores.

A server may also have "fabric-attached" resource devices that are external to the server. In this context, a "fabric-attached" resource device refers to a resource device that is associated with a server's coherent resource domain (e.g., the server's memory space) and is accessed by the server over a network infrastructure that includes one or multiple physical network switches (also called "fabric switches" herein).

A fabric-attached resource device may be physical (or "actual") or virtual. In an example, a physical fabric-attached resource device may correspond to a physical memory partition of a physical, resource donor device, such as a smart input/output (I/O) peripheral, a memory expansion device or a server. In another example, a physical fabric-attached donor resource may provide a collection of virtual, or logical, fabric-attached devices. A fabric-attached donor device may provide a collection of pooled resource devices, a collection of shared resource devices, or a combination of the foregoing. A pooled resource device is allocated to a single server, whereas a shared resource device is shared by multiple servers.

Resource pooling and sharing may be particularly beneficial in a data center. A given server may have inadequate on-board memory and/or GPU cores to fully support the device's application workloads, whereas other components of the data center may have otherwise underutilized (or "stranded") resources. Moreover, resource pooling and sharing allows the addition of expansion devices to the data center's network fabric to scale up the data center's workload capacity.

In an example of resource sharing among servers of a data center, the servers may host microservices of a particular microservice-based application. The microservices share fabric-attached memory that corresponds to a coherent memory domain. In another example of resource sharing, a data center may include a high-performance computing (HPC) cluster of servers, and workloads of the cluster share fabric-attached GPUs and fabric-attached memory.

A data center may include an entity called a "fabric manager," which allocates pooled and shared fabric-attached resource devices for servers of the data center. More specifically, the fabric manager responds to resource allocation requests (e.g., application programming interface (API) calls). In an example, a resource allocation request to allocate shared memory for a pair of servers may specify a particular size and type of memory.

In one approach, a fabric manager does not consider data center metrics when allocating fabric-attached resource devices. Workloads running on the servers expect predictable performances when accessing fabric-attached resource devices. Not considering data center metrics may result in the workloads of a server experiencing unacceptable delays, or latencies, when accessing a fabric-attached resource device. Moreover, for workloads on multiple servers that share a fabric-attached resource device of a coherent resource domain, a large access latency for one or both servers may result in inconsistent workload behaviors. There are a number of factors, which may contribute to the latency that a workload experiences when accessing a fabric-attached resource device. In examples, these factors include the number of network switches (or "hops") between the workload's server and the fabric-attached resource device; network switch processing times; network congestion; and resource-specific attributes.

In accordance with example implementations that are described herein, a data center metric-based composition engine (also called a "composition engine" herein) generates a data structure that represents data center metric information for fabric-attached resource devices. A fabric manager allocates fabric-attached resource devices based on the data center metric information.

More specifically, in accordance with example implementations, the fabric manager is constructed to allocate fabric-attached resource devices for hosts of the data center. A "host" refers to an entity of a compute node (e.g., a "server"), which provides one or multiple application operating environments (e.g., a bare-metal environment or virtual machines) in which application workloads run, or execute. A host has associated local resources, and a given host may have (as allocated by the fabric manager) one or multiple fabric-attached resource devices. Hosts are connected to fabric-attached resource devices by host-resource interconnection fabric (e.g., fabric switches, such as top-of-the rack (ToR) switches, as well as interconnecting links). In accordance with example implementations, the data structure that is generated by the composition engine represents the hosts; the fabric-attached resource devices (both allocated and unallocated); connection paths between the hosts and the fabric-attached resource devices; and associated data center metrics as a bipartite graph.

More specifically, a bipartite graph G may be represented as "G = (V,E)," where "V" represents nodes, or vertices; and "E" represents edges. The vertices V are subdivided into a first set of vertices that correspond to respective hosts (or the fabric switches directly connected to the hosts) and a second set of vertices that correspond to respective resource devices. The edges E correspond to paths of the host-resource interconnection fabric. The edges E interconnect the vertices of the first set (corresponding to the hosts) with the vertices of the second set (the resource devices). A path may include one or multiple links. A link may also be referred to as a "hop." Each link extends between two fabric switches (also called "network switches" herein). In an example, a link may be a network cable that is connected to physical ports of two respective fabric switches. As can be appreciated, a particular path includes H links (where "H" is an integer, such as 1, 2 or so forth) and H+1 fabric switches.

In accordance with the bipartite graph topology, each vertex of the first set is connected by one of the edges to a vertex of the second set, none of the vertices of the first set are connected to one another, and none of the vertices of the second set are connected to one another. In accordance with example implementations, the bipartite graph G is a minimum latency bipartite graph, which identifies minimum latency paths to interconnecting hosts and resource devices. More specifically, although a given host may reach a given resource device over potentially one of multiple paths, the bipartite graph G includes a single edge between a given host vertex and a given resource device vertex. This single edge corresponds to the lowest latency path between the given host vertex and the given resource device vertex. In accordance with example implementations, the edges of the bipartite graph G are assigned respective weights (called "latency weights"), with each weight representing the latency of the corresponding path.

The fabric manager makes fabric-attached resource device allocation decisions based on the bipartite graph G. In an example, in response to a resource allocation request to allocate a pooled fabric-attached resource device for a particular host, the fabric manager selects the available fabric-attached resource device that has the lowest corresponding access latency. Moreover, the fabric manager configures the interconnection fabric to route traffic between the host and the fabric-attached resource device over the minimum latency path specified by the bipartite graph G. In another example, in response to a resource allocation request to allocate a shared resource for a pair of hosts, the fabric manager selects an unallocated shared resource based on the latencies represented by the bipartite graph G. Moreover, the fabric manager configures the interconnection fabric to route traffic between the hosts and the fabric-attached resource device based on the paths specified by the bipartite graph G. As further described herein, in accordance with example implementations, the fabric manager allocates fabric-attached resources in a way that preserves a bipartite matching property for unallocated fabric-attached resources. Preserving the matching property ensures that each host has an opportunity to share a fabric-attached resource.

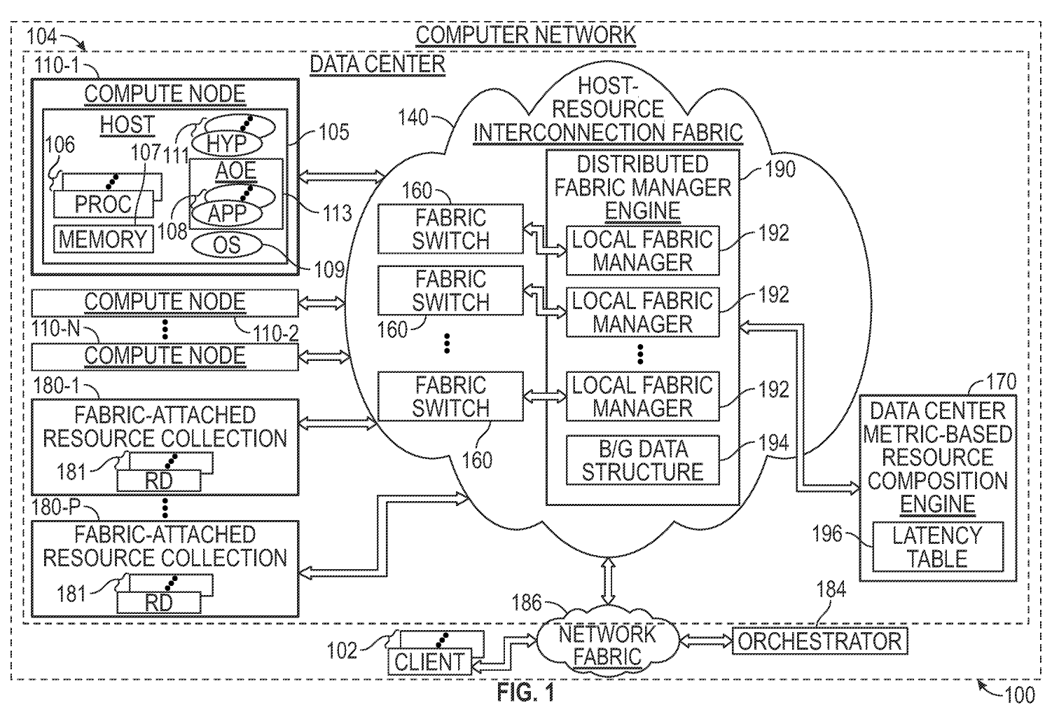

Referring to FIG. 1, as a more specific example, a computer network 100 includes N compute nodes 110 (compute nodes 110-1, 110-2 to 110-N being depicted in FIG. 1), client devices 102 and network fabric 186 that interconnects the compute nodes 110 and the client devices 102. In accordance with example implementations, the network fabric 186 may be associated with one or multiple types of communication networks, such as Compute eXpress Link (CXL) fabric, dedicated management networks, local area networks (LANs), wide area networks (WANs), global networks (e.g., the Internet), wireless networks, or any combination thereof.

The compute nodes 110 are located in a data center 104. In accordance with example implementations, the data center 104 may be associated with a cloud. In the context that is used herein, a "cloud" refers to a computer system that is associated with resources that can be scaled up and down on demand. In a more specific example, the data center 104 corresponds to a business entity's private cloud that is managed by the business entity. In an example, the data center 104 is a co-location data center. In another example, the data center 104 is located on-premise on the business entity's private property. In another example, the data center 104 corresponds to a hybrid cloud that is managed by a public cloud operator, and the data center 104 is located on- premise or corresponds to a co-location data center. In another example, the data center 104 corresponds to a public cloud that is owned and managed by a public cloud operator, and the public cloud provides cloud services to the general public.

A "compute node," in the context that is used herein, corresponds to a computer platform. In this context, a "computer platform" is an assembly that includes a frame, or chassis, and hardware that is mounted to the chassis and which supports the execution of machine-readable instructions (or "software"). In an example, the compute nodes 110 are rack-based chassis units. In general, a "compute node" may be any processor-based device, such as a rack-mountable modular chassis unit, an enclosure-based server (e.g., a blade server) or a rack mount server (e.g., a density line (DL) server). In another example, a compute node 110 may be non-rack-based (e.g., a tower server).

FIG. 1 depicts exemplary components of a particular compute node 110-1. Although the architectures and component inventories of the compute nodes 110 may vary, in accordance with example implementations, each compute node 110, in general, supports the execution of one or multiple application workloads.

A compute node's host (e.g., the host 105) provides one or multiple application operating environments (e.g., application operating environment 113 of the compute node 110-1) in which application workloads execute. In examples, an application operating environment may be a bare-metal server or a virtual environment (e.g., a virtual machine, a container or a combination thereof). In this context, an "application workload" (or "workload") refers to a collection of one or multiple application processes (e.g., application processes108), such as a single application process or multiple application processes that operate under the same identity.

The data center 104 includes host-resource interconnection fabric 140 that interconnects hosts of the compute nodes 110 with P collections of fabric-attached shared and/or pooled resources 180 (called "resource collections 180," with collections 180-1 and 180-P being specifically depicted in FIG. 1). As also depicted in FIG. 1, the host-resource interconnection fabric 140 may be connected to or be part of the network fabric 186. In accordance with example implementations, each resource collection 180 includes one or multiple resource devices 181. In an example, a resource device 181 is a virtual device (e.g., a logical memory device or a logical GPU core). In another example, a resource device 181 is an actual, or physical device (e.g., a memory partition or a physical GPU core).

In an example, the resource devices 181 of a particular resource collection 180 correspond to respective physical memory regions of a memory pool, and each physical memory region is not shared and may be allocated to a specific host. In another example, the resource devices 181 of a particular resource collection 180 correspond to respective virtual memory regions that may be shared by multiple hosts. In another example, the resource devices 181 of a particular resource collection 180 correspond to both shared and pooled memory regions. In another example, the resource devices 181 of a particular resource collection 180 correspond to respective physical GPUs of a GPU pool, and each physical GPU may be allocated to a particular host. In another example, the resource devices 181 of a particular resource collection 180 are virtual GPUs that may be shared by multiple hosts. In another example, the resource devices 181 of a particular resource collection 180 correspond to both shared and pooled GPUs. In another example, the resource devices 181 of a particular resource collection 180 correspond to both virtual and physical devices.

In accordance with example implementations, a physical donor device provides a corresponding resource collection 180. A compute node 110 is an example of such a physical donor device. An accelerator is another example of a physical donor device. A memory expansion device is another example of a physical donor device. A smart input/output (I/O) peripheral of a compute node 110 is another example of a physical donor device. In this context, a "smart I/O peripheral" refers to a component of a compute node 110, which provides one or multiple functions for a host of the compute node 110, which, in legacy architectures were controlled by the host. A smart I/O peripheral may be also be referred to as a "data processing unit" (or "DPU") or an "infrastructure processing unit (or "IPU"). In general, a smart I/O peripheral is a hardware processing unit that has been assigned (e.g., programmed with) a certain personality. A smart I/O peripheral may provide one or multiple backend I/O services (or "host offloaded services) in accordance with its personality. The backend I/O services may be non-transparent services (e.g., hypervisor virtual switch offloading services) or transparent services (encryption services, compression services, packet processing services, overlay network access services and firewall-based network protection services). A smart I/O peripheral abstracts network interfaces and presents the interfaces to the host as one or multiple network interfaces controllers (or "NICs").

In an example, the host-resource interconnection fabric 140 is a CXL fabric that complies with the Compute Express Link 3.1 Specification, Revision 3.1, which was published August 2023, and which is available from the CXL Consortium. The host-resource interconnection fabric 140 includes fabric switches 160 (or "network switches"). In an example, the fabric switch 160 is a ToR switch. In another example, the fabric switch 160 may be a switch other than a ToR switch. In other examples, the host-resource interconnection fabric 140 may be a CXL fabric that complies with a CXL specification other than the CXL 3.1 Specification or the host-resource interconnection fabric 140 may comply with an over-fabric standard other than CXL, such as a Remote Direct Memory Access (RDMA) standard, a Cache Coherent Interconnect for Accelerators (CCIX) topology standard, an Infiniband transport standard or a Fibre Channel transport standard.

A distributed fabric manager engine 190 of the host-resource interconnection fabric 140 processes resource allocation requests for purposes of allocating fabric-attached resource devices 181 for hosts of the data center 104. In an example, a resource allocation request specifies allocation of a pooled resource 181 for a particular host. In another example, a resource allocation request specifies allocation of a shared resource 181 to be shared by multiple hosts. In the context used herein, "allocating" a particular resource device 181 refers to the distributed fabric manager engine 190 performing actions to select the resource device 181 and configure components of the data center 104 so that the host(s) may access the resource device 181. In an example, allocating a particular resource device 181 includes the distributed fabric manager engine 190 identifying a collection of available candidate resource devices 181 that satisfy the storage allocation request and selecting a resource device 181 from the collection. In another example, allocating a particular resource device 181 includes the distributed fabric manager engine 190 providing an identifier of the selected resource device 181 to the host(s).

In accordance with example implementations, allocating a particular resource device 181 includes the distributed fabric manager engine 190 configuring the host-resource interconnection fabric 140 so that a host uses a specific path for traffic communicated between the host and the resource device 181. A path between a host and a particular resource device 181 includes one or multiple links (or "hops"), with each link being terminated at either end by a fabric switch 160. In an example, a link corresponds to cabling between ports of a pair of fabric switches 160. In an example, allocating a particular resource device 181 to be shared by multiple hosts includes the distributed fabric manager engine 190 configuring fabric switches 160 (e.g., setting up the corresponding port-based routing (PBR)) to route communications between the resource device 181 and each host over a specific path of the host-resource interconnection fabric 140.

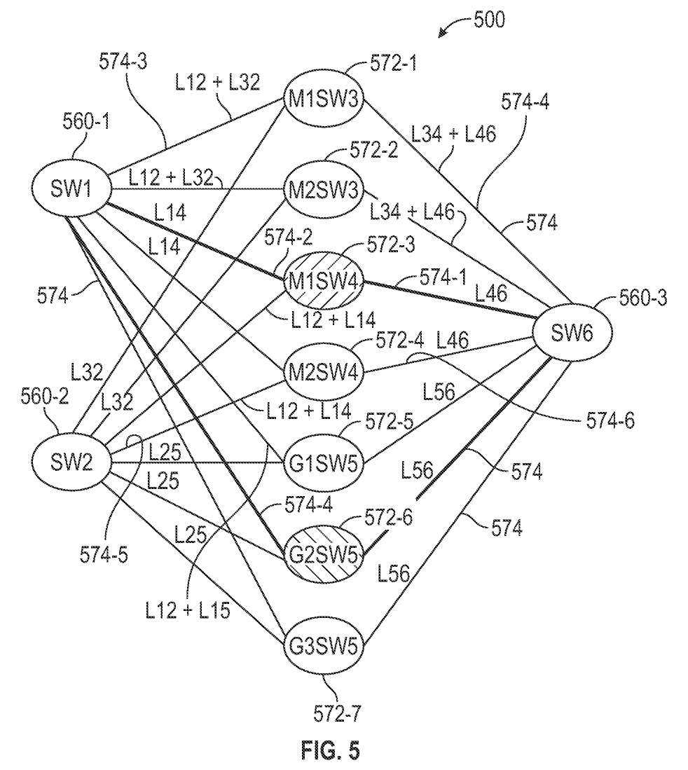

As described further herein, the distributed fabric manager engine 190 bases resource device and resource device path selections on a bipartite graph. The bipartite graph is represented by a bipartite graph data structure 194. More specifically, in accordance with example implementations, a bipartite graph G may be described by "G = (V,E)," where "V" represents the nodes, or vertices, of the bipartite graph G, and "E" represents the edges of the bipartite graph G. The vertices V may be decomposed into a first set of vertices V_{H} that correspond to respective hosts (or the fabric switches 160 directly connected to the hosts) and a second set of vertices V_{RD} that correspond to respective resource devices 181. FIG. 5, which is described further below, is an example of the bipartite graph G.

Unless otherwise stated herein, it is assumed that in the following discussion, the resource device vertices V_{RD} correspond to respective shared resource devices 181. However, it is noted that in accordance with further example implementations, the bipartite data structure 194 may represent a bipartite graph that includes pooled resource devices 181, and the distributed fabric manager engine 190 may use the bipartite graph to allocate pooled resource devices 181.

In accordance with example implementations, each edge E of the bipartite graph G represents the lowest latency path between a host (represented by a corresponding host vertex V_{H}) and a resource device 181 (represented by a corresponding resource device vertex V_{RD}). As described further herein, the distributed fabric manager engine 190, in response to a resource sharing allocation request, applies one or multiple selection criteria (e.g., select the lowest latency path, as indicated by the bipartite graph G) to select a candidate unallocated, or unused, resource device 181 (called the "candidate resource device 181" herein). For the selected candidate resource device 181, the bipartite graph G identifies respective minimum latency paths (corresponding to edges E) between the selected candidate resource device 181 and the hosts. Therefore, the selection of a candidate resource device 181 also selects specific paths to be used by the respective hosts to access the candidate resource device 181.

In accordance with example implementations, the distributed fabric manager engine 190 makes resource device 181 selections in a way that preserves a matching property of the bipartite graph G for the remaining available (i.e., unallocated) resource devices 181. A bipartite graph has a "matching property" if there is a subset M of edges of the bipartite graph such that no two edges of the subset M share the same vertex in the bipartite graph. The distributed fabric manager engine 190 considers whether the selection of a candidate resource device 181 preserves the matching property. For this evaluation, the distributed fabric manager engine 190 evaluates a bipartite graph G_{EVAL}, which is derived from the bipartite graph G. The bipartite graph G_{EVAL} includes the vertices of the minimum bipartite graph G, except for vertices that corresponds to allocated (or "used") resource devices 181 and the vertex corresponding to the selected candidate resource device 181.

If the bipartite graph G_{EVAL} has a matching property, then the distributed fabric manager engine 190 proceeds with allocating the candidate resource device 181 to satisfy the resource allocation request. If, however, the bipartite graph G_{EVAL} does not have a matching property, then this means that not all of the hosts have an opportunity to share one of the remaining unallocated shared resource devices 181. Consequentially, the distributed fabric manager engine 190 proceeds to deselect the candidate resource device 181 and apply a selection criterion to select and evaluate another candidate resource device 181. The distributed fabric manager engine 190 repeats the selection and matching property evaluation until the distributed fabric manager engine 190 selects a resource device 181 that preserves the matching property.

In accordance with example implementations, each fabric switch 160 is associated with a switch-specific, or local, fabric manager 192. The distributed fabric manager engine 190 includes the collection of local fabric managers 192. In examples, a local fabric manager 192 may be hosted on the associated fabric switch 160 or other entity of the data center 104. The local fabric manager 192 is constructed to discover, or detect, all immediate neighbor fabric switch(es) 160 connected to the associated fabric switch 160. Moreover, the local fabric manager 192, in accordance with example implementations, determines latencies for the links extending to the immediate neighbor fabric switch(es) 160 and stores a table that includes entries representing the latencies. In the following discussion, a fabric switch 160 may provide immediate neighbor information, such as latencies of the neighbor links as well as information identifying neighbor switches. For this purpose, the fabric switch's local fabric manager 192 may provide this information.

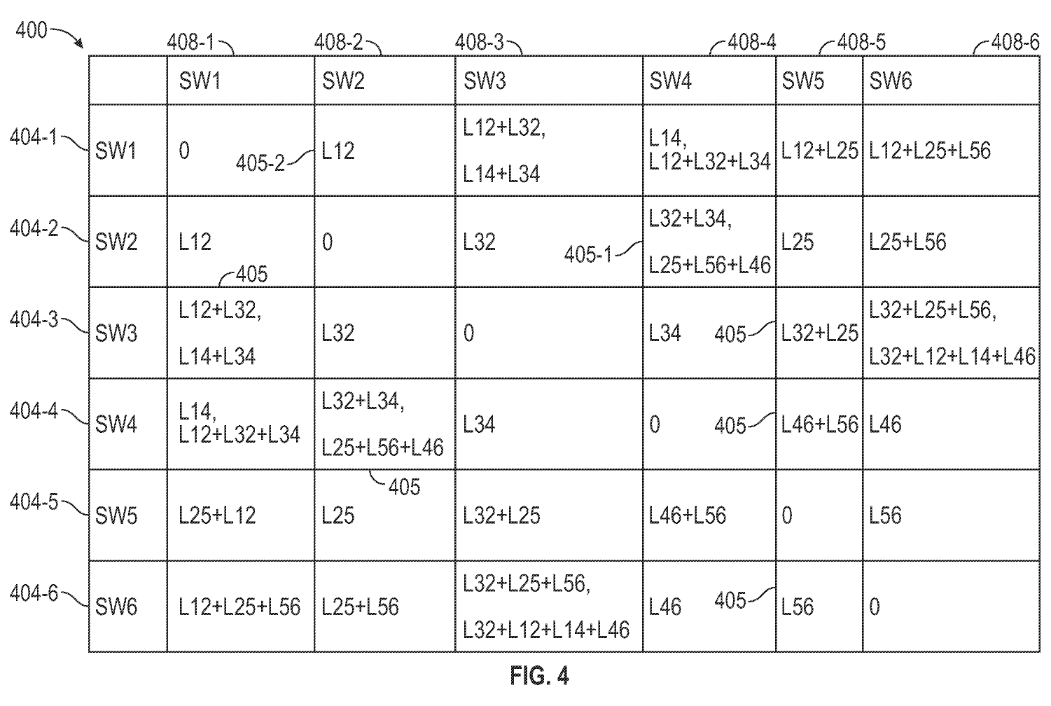

In accordance with example implementations, a data center metric-based resource composition engine 170 (called the "resource composition engine 170" herein) communicates with the fabric switches 160 to discover all of the resource devices 181 that are connected to the host-resource interconnection fabric 140. Moreover, the resource composition engine 170 communicates with the fabric switches 160 to determine, for each host, all paths that the host may use to reach each resource device 181. It is noted that in some cases, a particular resource device 181 may be unreachable by a particular host. The resource composition engine 170 also communicates with the fabric switches 160 to discover the latencies of the respective links of each path. From this information, the resource composition engine 170 constructs a latency table 196 that contains records. Each record is associated with a particular host and resource device pair and contains the latencies of respective path(s) between the host and the resource device 181. An example latency table 196 is discussed below in connection with FIG. 4.

Still referring to FIG. 1, from the latency table 196, the resource composition engine 170 identifies the lowest latency path between each host and each resource device 181. The resource composition engine 170 uses the identified lowest latency paths to construct the bipartite data structure 194, which is used by the distributed fabric manager engine 190 to allocate resource devices 181 for hosts, as described herein. In accordance with example implementations, the resource composition engine 170 monitors latencies of the paths in real time or near real time, and the resource composition engine 170 updates the bipartite data structure 194 responsive to any minimum latency path between a host and a resource device 181 changing. Moreover, in accordance with example implementations, the resource composition engine 170 considers network congestion in constructing the bipartite data structure 194 for purposes of avoiding allocations that would result in unacceptable latencies due to network congestion.

As used herein, an "engine," such as the distributed fabric manager engine 190 and/or the resource composition engine 170, can refer to one or more circuits. For example, the circuits may be hardware processing circuits, which can include any or some combination of a microprocessor, a core of a multi-core microprocessor, a microcontroller, a programmable integrated circuit (e.g., a programmable logic device (PLD), such as a complex PLD (CPLD)), a programmable gate array (e.g., field programmable gate array (FPGA)), an application specific integrated circuit (ASIC), or another hardware processing circuit. An "engine" can refer to a combination of one or more hardware processing circuits and machine-readable instructions (software and/or firmware) executable on the one or more hardware processing circuits. In an example, the distributed fabric manager engine 190 and/or the resource composition engine 170 may be formed by one or multiple hardware processors (e.g., hardware processors 106 of compute node 110-1) executing hardware processor-readable instructions that are stored in a memory (e.g., the memory 107 of the compute node 110-1). In another example, the distributed fabric manager engine 190 and/or the resource composition engine 170 may be formed in whole or in part by a PLD, ASIC, FPGA or other hardware.

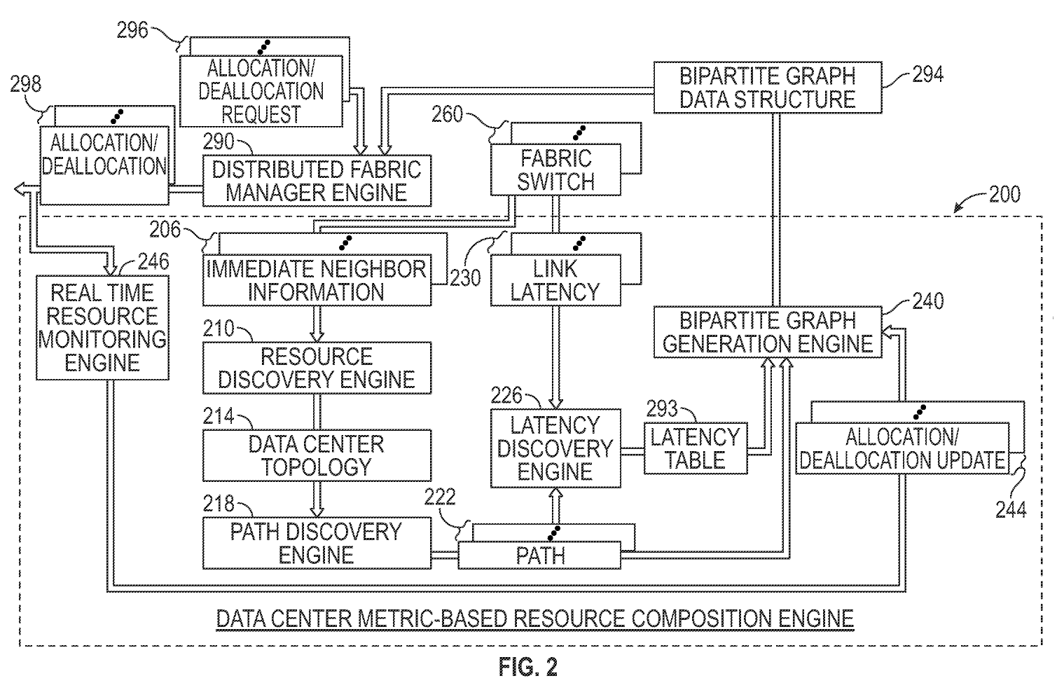

FIG. 2 depicts a block diagram of a data center metric-based resource composition engine 200 (called a "resource composition engine 200" herein) in accordance with example implementations. The resource composition engine 170 of FIG. 1 is an example of the resource composition engine 200. The resource composition engine 200 generates and updates a bipartite graph data structure 294 that is used by a distributed fabric manager engine 290 to allocate fabric-attached resource devices for hosts of a data center. The distributed fabric manager engine 290 processes requests 296. A request to allocate a shared fabric-attached resource is an example of a request 296. A request to deallocate a shared fabric-attached resource is another example of a request 296. A request to allocate a pooled fabric-attached resource is another example of a request 296. A request to deallocate a pooled fabric-attached resource is another example of a request 296. As depicted at 298, responsive to a particular request 296, the distributed fabric manager engine 290 may take actions to allocate a fabric-attached resource device for a host or deallocate a particular fabric-attached resource device. The distributed fabric manager engine 190 of FIG. 1 is an example of the distributed fabric manager engine 290.

In connection with a boot of the distributed fabric manager engine 290, the resource composition engine 200 transitions through a resource discovery phase, a path discovery phase and a latency discovery phase. During the resource discovery phase, a resource discovery engine 210 of the distributed fabric manager engine 290 communicates with fabric switches 260 (e.g., the fabric switches 160 of FIG. 1) of the data center to discover all resource devices that are attached to the host-resource interconnection fabric. For this purpose, the distributed fabric manager engine 290 may communicate with local fabric managers associated with the fabric switches 260. Each fabric switch 260 provides information 206 (e.g., an IP address, a MAC address, a device type and so forth) about its immediate neighbor (e.g., a fabric switch 260, a host or a resource device). The resource discovery engine 210 aggregates the immediate neighbor information 206 to provide data that represents a data center topology 214. The data center topology 214 represents the components and interrelationships of the data center, including the hosts, the fabric-attached resource devices, fabric switches and links interconnecting the fabric switches. Moreover, the data center topology 214 identifies the fabric switches that are directly attached to the resource devices and hosts. A particular fabric switch may be directly connected to multiple resource devices.

The resource composition engine 200 further includes a path discovery engine 218. During the path discovery phase, the path discovery engine 218 uses the data center topology 214 as an input to determine, for each host and fabric-attached resource device pair, the one or multiple paths between these entities. If a collection of resource devices is directly connected to the same fabric switch, then each resource device of the collection is reachable from each host by the same set of paths. For a given host and fabric-attached resource device pair, there may be zero, one or multiple paths over which the host can reach the resource device. The path discovery engine 218 generates path information datasets 222 that represent the discovered paths.

In an example, the path discovery engine 218 identifies, from the data center topology 214, the fabric switches (called the "resource device-attached fabric switches" herein) that are directly connected to resource devices and the fabric switches (called the "host-attached fabric switches" herein) that are directly connected to the hosts. For each resource device-attached fabric switch and host-attached fabric switch pair, the path discovery engine 218 determines the one or multiple paths between the pair, and the path discovery engine 218 generates a corresponding path information dataset 222 that represents the paths.

During the latency discovery phase, a latency discovery engine 226 of the resource composition engine 200 determines the latencies of all paths that were discovered by the path discovery engine 218. This determination involves determining the latency of each link of each path. In an example, as depicted in FIG. 2, for this purpose, the latency discovery engine 226 communicates with the fabric switches 260 to acquire link latencies 230. In an example, the link latencies 230 may be derived by the latency discovery engine 226 reading coherent device attribute tables (CDATs).

Based on the link latencies 230 and the path information datasets 222, the latency discovery engine 226 generates a latency table 293. In accordance with example implementations, the latency table 293 contains data representing the latencies between each combination of host-attached fabric switches 260 and resource device-attached fabric switches 260. The latency table 293, for each combination, contains data representing one or multiple latencies, depending on whether one or multiple paths exist between the combination.

A bipartite graph generation engine 240 of the resource composition engine 200 generates a bipartite graph (represented by the bipartite graph data structure 294) that is used by the distributed fabric manager engine 290 to allocate resource devices for hosts. The bipartite graph includes vertices corresponding to respective hosts and resource devices, and the bipartite graph includes a single edge extending between each host and resource device pair. The single edge corresponds to the path to be selected by the distributed fabric manager engine 290 should the engine 290 allocate the resource device for the host. The edges of the bipartite graph, in accordance with example implementations, have respective associated latency weights.

The distributed fabric manager engine 290 selects resource devices for hosts based on the latency weights. In an example, responsive to a request 296 to allocate a pooled resource device for a host, the distributed fabric manager engine 290, based on the bipartite graph, identifies a collection of candidate pooled resource devices that are reachable by the host. Continuing the example, based on the collection of candidate pooled resource devices, the distributed fabric manager engine 290 selects the pooled resource device of the collection, which is associated with the path that has the lowest latency weight. In another example, responsive to a request 296 to allocate a shared resource device for multiple hosts (e.g., two hosts), the distributed fabric manager engine 290, based on the bipartite graph, identifies a collection of candidate shared resource devices that are reachable by the hosts. Based on the collection of candidate shared resource devices, the distributed fabric manager engine 290 selects the shared resource device of the collection having associated paths with the lowest latency weights.

In addition to including data representing the host vertices, the resource device vertices, the edges and the latency weights, the bipartite graph data structure 294 includes data representing the allocation status of each resource device. In an example, the bipartite graph data structure 294 includes data representing whether each resource device is allocated (or "used") or is unallocated (or "unused"). Moreover, the bipartite graph data structure 294 includes, for each edge, data (e.g., fabric switch identifiers, port identifiers or other information) that identifies the corresponding path.

For purposes of generating the bipartite graph, the bipartite graph generation engine 240 uses the path information datasets 222 to identify, for each host and resource device pair, the one or multiple candidate paths that may be used by the host to reach the resource device. The bipartite graph generation engine 240 adds the link latencies of each path to determine the latency of each candidate path.

For each host and resource device pair, the bipartite graph generation engine 240 selects a path for inclusion in the bipartite graph based on the latencies of the corresponding candidate paths. In an example, bipartite graph generation engine 240 selects the candidate path that has the lowest latency.

In another example, the bipartite graph generation engine 240 selects a candidate path for inclusion in the bipartite graph based on the path's latency and one or multiple other selection criteria. For example, the bipartite graph generation engine 240 considers whether candidate paths are already being used in whole or in part to access one or multiple allocated resource devices. In a more specific example, although a candidate path for a particular resource device has the lowest latency among the candidate paths, the bipartite graph generation engine 240 selects another candidate path to preemptively prevent congestion.

In an example, due to the number of resource device(s) that are already wholly or partially assigned to the lowest latency candidate path, the bipartite graph generation engine 240 selects the second lowest latency candidate path (or perhaps, as another example, selects the third lowest latency candidate path). In an example, the bipartite graph generation engine 240 sets a threshold on the number of resources devices that may be assigned to the same path and considers this threshold in addition to considering path latency. In an example, the bipartite graph generation engine 240 sets a threshold on the number of resources devices that may be assigned to one or multiple links of the same path. In an example, the threshold may be based on the type of resource device.

In addition to generating an initial version of the bipartite graph in connection with a boot up of the distributed fabric manager engine 290, the bipartite graph generation engine 240 updates the bipartite graph (and therefore, updates the bipartite graph data structure 294) to reflect changes in data center metrics, resource device allocations and resource device deallocations. For this purpose, a real time resource monitoring engine 246 of the composition engine 200 monitors resource device allocations and deallocations and provides corresponding updates 244 to the bipartite graph generation engine 240. Responsive to the updates, the bipartite graph generation engine 240 updates the bipartite graph data structure 294 with the allocation and/or deallocation changes for the bipartite graph's resource device vertices. Moreover, in accordance with example implementations, responsive to the updates 244, the bipartite graph generation engine 240 takes resource device allocations and deallocations into consideration for purposes of selecting paths to include in the bipartite graph in a way that preempts network congestion.

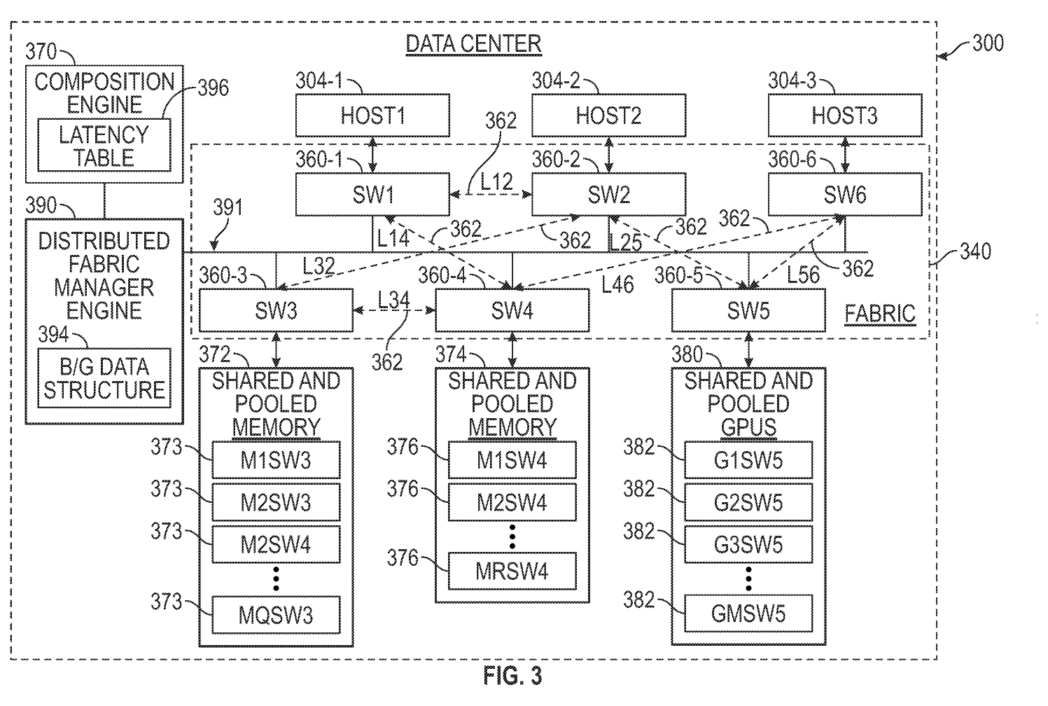

FIG. 3 depicts a data center 300 in accordance with an example implementation. The components and architecture of the data center 300 are simplified to illustrate the allocation of resource devices based on data center metrics. The data center 300 includes a distributed fabric manager engine 390 that allocates resource devices 373, 376 and 382 for hosts 304-1, 304-2 and 304-3 based on a bipartite graph data structure 394. The bipartite graph data structure 394 includes data that represents a bipartite graph and is generated by a composition engine 370. The distributed fabric manager engine 190 of FIG. 1 and the distributed fabric manager engine 290 of FIG. 2 are examples of the distributed fabric manager engine 390. The composition engine 170 of FIG. 1 and the composition engine 270 of FIG. 2 are examples of the composition engine 370 of FIG. 3.

The resource devices 373, 376 and 382 are reachable by the hosts 304-1, 304-2 and 304-3 via host-resource interconnection fabric 340. The host-resource interconnection fabric 340 includes fabric switches 360-1, 360-2 and 360-6 that are directly connected to the hosts 304-1, 304-2 and 304-3, respectively. The host-resource interconnection fabric 340 also includes fabric switches 360-3, 360-4 and 360-5, respectively, that are directly connected to a shared and pooled memory 372 (containing the resource devices 373), a shared and pooled memory 374 (containing the resource devices 376) and a shared and pooled GPU collection 380 (containing the resource devices 382), respectively. Although not depicted in FIG. 3, in accordance with further implementations, the host-resource interconnection fabric 340 may further include one or multiple fabric switches interconnecting the host-attached fabric switches 360-1, 360-2 and 360-6 with the resource device-attached fabric switches 360-3, 360-4 and 360-5. Because the fabric switches 360-1, 360-2 and 360-6 are directly connected, or attached, to respective hosts 304, the fabric switches 360-1, 360-2 and 360-6 are also referred to herein as "host-attached fabric switches 360." In a similar manner, because the fabric switches 360-3, 360-4 and 360-5 are directly connected, or attached, to respective resource devices, the fabric switches 360-3, 360-4 and 360-5 are also referred to herein as "resource device-attached fabric switches 360."

The shared and pooled memory 372 includes Q resource devices 373, the shared and pooled memory 374 includes R resource devices 376, and the shared and pooled GPU collection 380 includes M resource devices 382. The distributed fabric manager engine 390 communicates with the fabric switches 360 via a fabric management infrastructure 391. In an example, the fabric management infrastructure 391 includes local fabric managers associated with respective fabric switches 360.

The fabric switches 360 are interconnected by links 362 (e.g., Peripheral Component Interconnect express (PCIe) links). Each link 362 has an associated latency. For example, the link 362 between the fabric switches 360-1 and 360-2 has a latency L12. In another example, the link 362 between the fabric switches 360-5 and 360-6 has a latency L56. It is assumed for this example, that there are negligible latencies between the host-attached switches 360-1, 360-2 and 360-6 and their respective hosts 304, and it is further assumed that there are negligible latencies between the resource device-attached fabric switches 360-3, 360-4 and 360-5 and their respective hosts 304. However, in accordance with further implementations, the composition engine 370 may take these latencies into consideration and incorporate into the bipartite graph.

A host 304 may potentially reach a particular resource over one or multiple paths, and each path includes one or multiple links 362. In an example, the host-resource interconnection fabric 340 provides two paths over which a host 304-1 may reach a resource 376. The first path includes the fabric switches 360-1 and 360-4 and the link 362 between the fabric switches 360-1 and 360-2. The first path has a latency of L14, which corresponds to the link latency between the fabric switches 360-1 and 360-4. The second path includes the fabric switches 360-1, 360-2, 360-3 and 360-4 and the interconnecting links 362. More specifically, from the host 304-1, the second path traverses the fabric switches 360 in the following order: the fabric switch 360-1, the fabric switch 360-2, the fabric switch 360-3 and then, the fabric switch 360-4. The second path has a latency that is the summation of the latency L12 (the link latency between the fabric switches 360-1 and 360-2), the latency L32 (the link latency between the fabric switches 360-2 and 360-3), and the latency L34 (the link latency between the fabric switches 360-3 and 360-4).

In another example, the host 304-1 may reach a resource 373 over one of two paths. The first path includes the fabric switches 360-1, 360-2 and 360-3 and the interconnecting links 362. The first path has a latency that is the summation of the latency L12 (the link latency between the fabric switches 360-1 and 360-2) and the latency L32 (the link latency between the fabric switches 360-2 and 360-3). The second path includes the fabric switches 360-1, 360-4 and 360-3 and the interconnecting links 362. The second path has a latency that is the summation of the latency L14 (the link latency between the fabric switches 360-1 and 360-4) and the latency L34 (the link latency between the fabric switches 360-3 and 360-4).

In another example, the host 304-3 may reach a resource 376 over a single path that includes the fabric switches 360-6 and 360-4 and the corresponding interconnecting link 362. For this example, the path has a latency L46.

The composition engine 370 constructs and maintains a data structure for purposes of tracking the latencies of paths between the host-attached switches 360 and the resource device-attached switches 360. In an example and as depicted in FIG. 3, the data structure is a latency table 396 having records that are indexed by an identifier for a host-attached switch 360 and an identifier for a resource device-attached switch 360. Each record contains data representing the corresponding path latency(ies). In another example, the data structure is a key-value store. For the key-value store the "key" is a combination of an identifier for a host-attached switch 360 and an identifier for a resource-attached switch 360; and the "value" corresponds to a blob, or record, that contains data representing the corresponding path latency(ies).

FIG. 4 depicts a latency table 400 in accordance with example implementations. The latency table 396 of FIG. 3 is an example of the latency table 400. The latency table 400 includes rows 404-1, 404-2, 404-3, 404-4, 404-5 and 404-6 that are associated with specific fabric switch identifiers of the host-resource interconnection fabric. Columns 408-1, 408-2, 408-3, 408-4, 408-5 and 408-6 of the latency table 400 are also associated with specific fabric switch identifiers of the host-resource interconnection fabric. In an example, the rows 404-1, 404-2, 404-3, 404-4, 404-5 and 404-6 are associated with respective identifiers for the fabric switches 360-1, 360-2, 360-3, 360-4, 360-5 and 360-6, respectively, of FIG. 3; and the columns 408-1, 408-2, 408-3, 408-4, 408-5 and 408-6 are associated with respective identifiers for the fabric switches 360-1, 360-2, 360-3, 360-4, 360-5 and 360-6, respectively, of FIG. 3.

The composition engine may use pair of fabric switch identifiers as an index or key to for a particular record 405 of the latency table 400. The record 405 contains data representing the latency(ies) for all paths between the corresponding fabric switches. In an example, the record 405-1 contains data representing latencies for two paths. More specifically, the record 405-1 contains data representing an identifier for a path and a latency (L32 + L34) of the path. Continuing the example, the record 405-1 further contains data representing an identifier for another path and a latency (L25 + L56 + L46) of this other path. In another example, a given record 405-2 contains a path identifier and latency L12 for a single path (the only path) between the corresponding fabric switches. Although not depicted in FIG. 4, in another example, a particular record may contain data representing path identifiers and latencies for more than two paths.

The composition engine, in accordance with example implementations, continually updates the latencies represented by the latency table 400 and continually re-evaluates the paths selected for inclusion in the bipartite graph based on the latencies. FIG. 5 depicts a bipartite graph 500 in accordance with example implementations. Referring to FIG. 5, the bipartite graph 500 includes host vertices 560-1, 560-2 and 560-3 that correspond to respective host-attached fabric switches. The bipartite graph 500 further includes resource device vertices 572-1, 572-2, 572-3, 572-4, 572-5, 572-6 and 572-7 that correspond to respective resource device-attached fabric switches. In an example, the host vertices 560-1, 560-2 and 560-3 correspond to the fabric switches 360-1, 360-2 and 360-6, respectively, of FIG. 3. In an example, the resource device vertices 572-1 and 572-2 are shared memory devices that correspond to shared memory devices 372 of FIG. 3; the resource device vertices 572-3 and 572-4 are shared memory devices that correspond to shared memory devices 376 of FIG. 3; and the resource device vertices 572-5, 572-6 and 572-7 are shared GPU devices that correspond to shared GPU devices 382 of FIG. 3. The corresponding bipartite graph data structure (e.g., the bipartite graph data structure 194 of FIG. 1 or the bipartite graph data structure 294 of FIG. 2) contains data representing the bipartite graph 500.

The bipartite graph 500 includes a single edge 574 between each host vertex 560 and each resource device vertex 572. Each edge 574 corresponds to the single path that has been selected by the composition engine for a corresponding host and resource device pair. A given resource device vertex 572 is associated with either an allocated (or "used") resource device or an unallocated (or "unused") resource device. As denoted by the shading of the resource device vertices 572-3 and 572-6 in the example of FIG. 5, the corresponding resource devices are allocated. In this manner, the resource device corresponding to the resource device vertex 572-3 is shared by the hosts corresponding to the host vertices 560-1 and 560-3. The host-resource interconnection fabric is configured so that the host corresponding to the host vertex 560-3 reaches the resource device corresponding to the resource device vertex 572-3 via a specific path represented by the edge 574-1. The host-resource interconnection fabric is configured so that the host corresponding to the host vertex 560-1 reaches the same resource device via a specific path represented by the edge 574-2. In a similar manner, the host-interconnection fabric is configured so that the hosts reach the resource device corresponding to the resource device vertex 572-6 via paths that are represented by respective edges 574 of the bipartite graph 500.

For the example of FIG. 5, the remaining resource devices corresponding to the resource device vertices 572-1, 572-2, 572-4, 572-5 and 572-7 are unallocated. A distributed fabric manager engine (e.g., the distributed fabric manager engine 190 of FIG. 1, the distributed fabric manager 290 of FIG. 2 or the distributed fabric manager engine 390 of FIG. 3) may use the bipartite graph 500 to, in response to a resource allocation request, select a resource device and select the path(s) for the host(s) to reach the resource device.

In an example, the distributed fabric manager engine may receive a request to allocate a shared memory device for the host devices corresponding the host vertices 560-1 and 560-3. For this example, the distributed fabric manager engine may select one of three candidate memory devices that correspond to resource device vertices 572-1, 572-2 and 572-4. It is noted that the memory device corresponding to the resource vertex 572-3 for this example is allocated or used. Moreover, for this example, the memory devices corresponding to the resource vertices 572-1 and 572-2 are co-located and therefore reachable by the same paths.

The distributed fabric manager engine selects the particular candidate memory device based on the latencies to reach the memory device. The candidate memory device corresponding to the resource vertex 572-1 is reachable by paths corresponding to edges 574-3 and 574-4. The path corresponding to the edge 574-3 has a latency of L12 + L32, and the path corresponding to the edge 574-4 has a latency of L34 + L46. The candidate memory device corresponding to the resource vertex 572-4 is reachable by paths corresponding to edges 574-5 and 574-6. The path corresponding to the edge 574-5 has a latency of L12 + L14, and the path corresponding to the edge 574-6 has a latency of L46. In an example, the distributed fabric manager engine adds the latencies associated with the respective paths for each memory device candidate and compares the latencies. More specifically, in an example, the distributed fabric manager engine compares a latency of option one of L12+L32+L34+L46 (the cumulative latency for the memory resource device corresponding to vertex 572-1) to the latency of option two of L12 + L14 + L46 (the cumulative latency for the memory resource device corresponding to the vertex 572-4). Based on this comparison, the distributed fabric manager engine selects the memory device having the lowest associated cumulative latency.

The distributed fabric manager engine may take into account other considerations other than the lowest latency when allocating a resource device. For example, in accordance with example implementations, the distributed fabric manager allocates fabric-attached resources in a way that preserves a matching property of the bipartite graph. Preserving the matching property ensures that each host has an opportunity to share a fabric-attached resource.

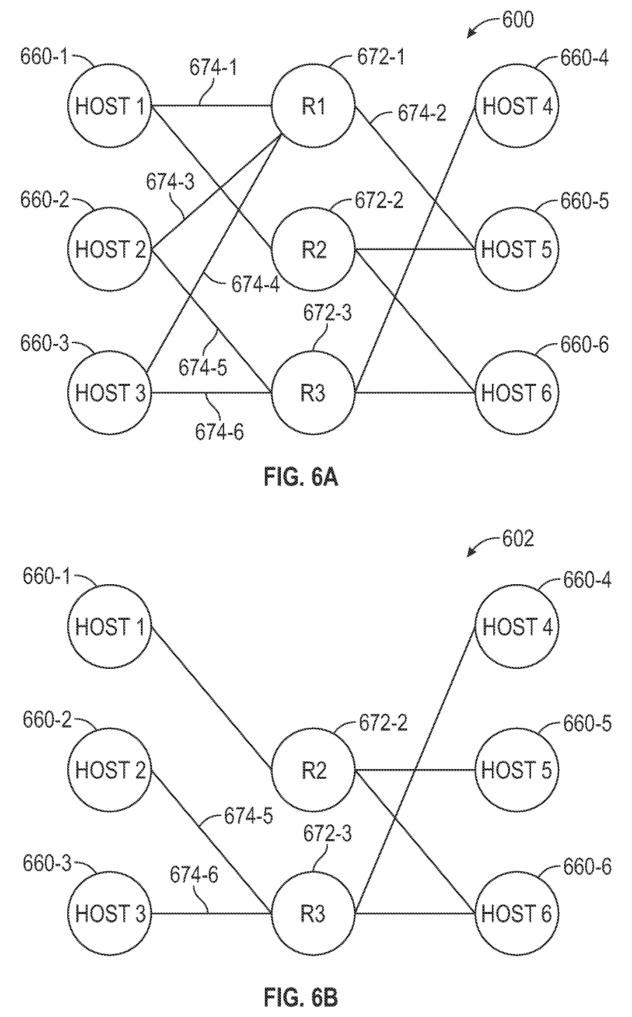

FIGS. 6A and 6B illustrate the distributed fabric manager engine's evaluation of a particular candidate resource device selection for purposes of determining whether selection of the candidate resource device violates, or does not satisfy, the bipartite matching property. More specifically, FIG. 6A depicts a bipartite graph 600, which has resource device vertices 672-1, 672-2 and 672-3 that correspond to respective resource devices that are available for allocation. As also depicted in FIG. 6A, the resource devices are reachable by hosts that are represented in the bipartite graph 600 by respective host vertices 660-1, 660-2, 660-3, 660-4, 660-5 and 660-6.

For this example, not all of the resource devices are reachable by the hosts. In this manner, the hosts represented by host vertices 660-2 and 660-3 cannot reach the resource device represented by the resource vertex 672-1. In another example, the hosts represented by hosts vertex 660-4 cannot reach the resource devices corresponding to resource device vertices 672-1 and 672-2. In other examples, the host represented by host vertex 660-5 cannot reach the resource device represented by resource vertex 672-3; and the host represented by host vertex 660-6 cannot reach the resource device represented by resource vertex 672-1.

The bipartite graph 600 satisfies the matching property. For this example, an edge 674-1 connects the host vertex 660-1 and the resource device vertex 672-1; an edge vertex 674-2 connects the host vertex 660-5 and the resource device vertex 672-1; an edge 674-3 connects the host vertex 660-2 to the resource device vertex 672-1; an edge 674-5 connects the host vertex 660-2 to the resource device vertex 672-3; and an edge 674-6 connects the host vertex 660-3 to the resource device vertex 672-3. In this manner, a subset of edges of the bipartite graph 600 may be selected such that each edge of this subset is connected to one host vertex 660 and one resource device vertex 672. However, it is possible that the allocation of a particular resource may result in a bipartite graph that no longer satisfies the matching property.

In an example, in response to a resource sharing allocation request, the distributed fabric manager engine may potentially allocate the resource device corresponding to the resource device vertex device 672-1 to the hosts that correspond to the host vertices 660-1 and 660-5. With this allocation, the resource device corresponding to the resource device vertex 672-1 becomes allocated (or "used"), and as a result, the bipartite graph 600 is transformed into a bipartite graph 602 of FIG. 6B. For purposes of evaluating whether the selection of the resource device satisfies the matching property, the distributed fabric manager engine considers whether the resulting bipartite graph 602 satisfies the matching property. More specifically, referring to FIG. 6B, the host devices corresponding to the host vertices 660-2 and 660-3 are connected to a single resource device (corresponding to the resource device vertex 672-3). The bipartite graph 602 does not satisfy, or violates, the matching property, as each host does not have a fair chance to be assigned to a resource device. Stated differently, the resource device corresponding to the resource device vertex 672-3 can only be assigned to one of the hosts corresponding to the host vertices 660-2 and 660-3. As such, a subset of edges cannot be selected from the bipartite graph 602 such that each edge of the subset is connected to one host vertex 660 and one resource device vertex 672. Therefore, for this example, the distributed fabric manager engine does not allocate the resource device corresponding to the resource device vertex 672-1 (FIG. 6A) to the hosts corresponding to the host vertices 660-1 and 660-4, as the allocation does not satisfy the matching property.

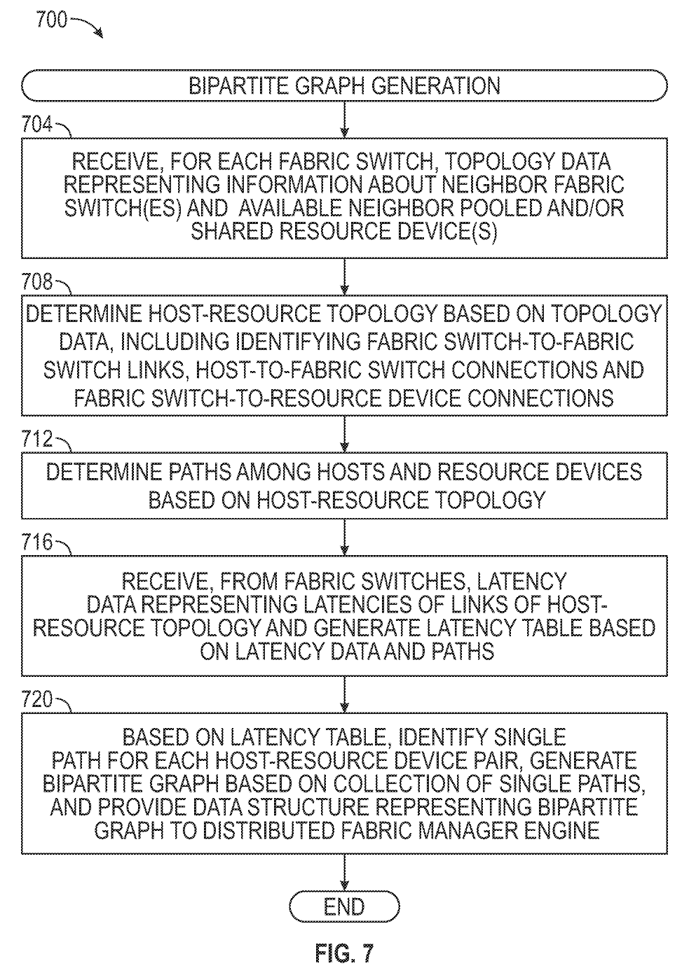

FIG. 7 is a flow diagram depicting a technique 700 used by a composition engine to generate a bipartite graph, in accordance with example implementations. The composition engine 170 of FIG. 1, the composition engine 200 of FIG. 2 and the composition engine 370 of FIG. 3 are examples of the composition engine.

Pursuant to block 704 of the technique 700, the composition engine receives, for each fabric switch, topology data representing information about the one or multiple neighbor fabric switches that are attached to the switch. Moreover, pursuant to block 704, the composition engine receives, for each fabric switch, information about any neighbor pooled and/or shared resources. Pursuant to block 708, the composition engine determines a host-resource topology based on the topology data. The host-resource topology includes fabric switch-to-fabric switch links, host-to-fabric switch connections and fabric switch-to-resource device connections.

Pursuant to block 712 of the technique 700, the composition engine determines paths among the hosts and resource devices based on the host-resource topology. A particular host may not be able to reach a particular resource device. For a reachable resource device, a particular host may reach the resource device through one or multiple paths. Each path includes multiple links, and each path includes one or multiple fabric switches.

Pursuant to block 716 of the technique 700, the composition engine receives, from the fabric switches, latency data representing latencies of the links of the host-resource topology. Pursuant to block 716, the composition engine generates a latency table based on the latency data and the paths. In accordance with example implementations, the latency table includes records for respective host-attached switch and resource device-attached switch pairs. For a pair associated with multiple paths, a record includes the associated latencies. For a pair associated with a single path, the record contains a single latency.

Pursuant to block 720 of the technique 700, the composition engine, based on the latency table identifies a single path for each host-resource device pair and generates a bipartite graph based on the identified single paths. In an example, a single path is the minimum latency path among the set of paths that may be used by a particular host to reach a particular resource device. In another example, the composition engine considers one or multiple factors other than latency. For example, the composition engine pre-emptively determines whether selection of a path could result in congestion making another path a better choice.

Pursuant to block 720, the composition engine generates, or provides, a data structure that represents the bipartite graph and provides the data structure to a distributed fabric manager engine. In an example, the data structure includes data representing host vertices corresponding to the hosts of a data center and resource device vertices corresponding to resource devices of the data center. In an example, the data representing the host vertices represents host identifiers corresponding to the respective hosts. In an example, the data representing the resource device vertices represents identifiers for the associated resource devices. Moreover, in accordance with example implementations, the data structure further includes data representing edges connecting the host and resource vertices. In an example, data representing an edge associates the edge with a latency weight and associates the edge with a path identifier. In another example, the data structure includes data representing a data center metric about the corresponding edge (or path) other than a latency weight.

In accordance with example implementations, the composition may continually revisit block 720 for purposes of updating the latency table and data structure to reflect real time or near real time changes in link latencies as well as real time or near real time changes to other data center metrics.

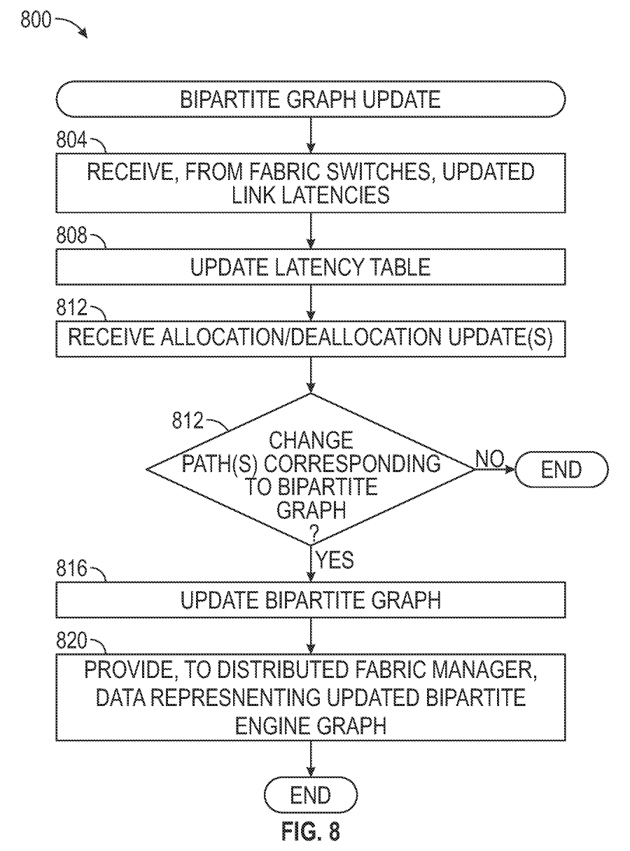

FIG. 8 is a flow diagram depicting a technique 800 that may be used by the composition engine for purposes of updating the bipartite graph. Pursuant to block 804, the composition engine receives, from the fabric switches, updated link latencies, and the composition engine updates (block 804) the latency table.

The composition engine further receives, pursuant to block 812 of the technique 800, allocation and/or deallocation updates. Based on the updated latencies and allocation/deallocation information, the composition may then determine, pursuant to decision block 812, whether any paths of the bipartite graph should be changed. In an example, a particular host and resource device pair has multiple paths, and with the updated latencies, a path other than the path indicated in the bipartite graph has the lowest latency.

In another example, based on allocation information, a particular path indicated by the bipartite graph is no longer an appropriate choice for an additional allocation due to predicted congestion among one or multiple links of the path. In another example, in view of deallocation information, although a particular alternative path is not included in the bipartite graph, due to resource device deallocation, the path is now the best choice for a particular host and resource device pair. If, pursuant to decision block 812, the composition engine determines to change one or multiple paths of the bipartite graph, then, pursuant to block 816, the composition engine updates the bipartite graph to effect the change(s). Pursuant to block 820 of the technique 800, the composition engine then provides, to the distributed fabric manager engine, data representing the updated bipartite graph. In an example, providing the data includes updating a data structure representing the bipartite graph.

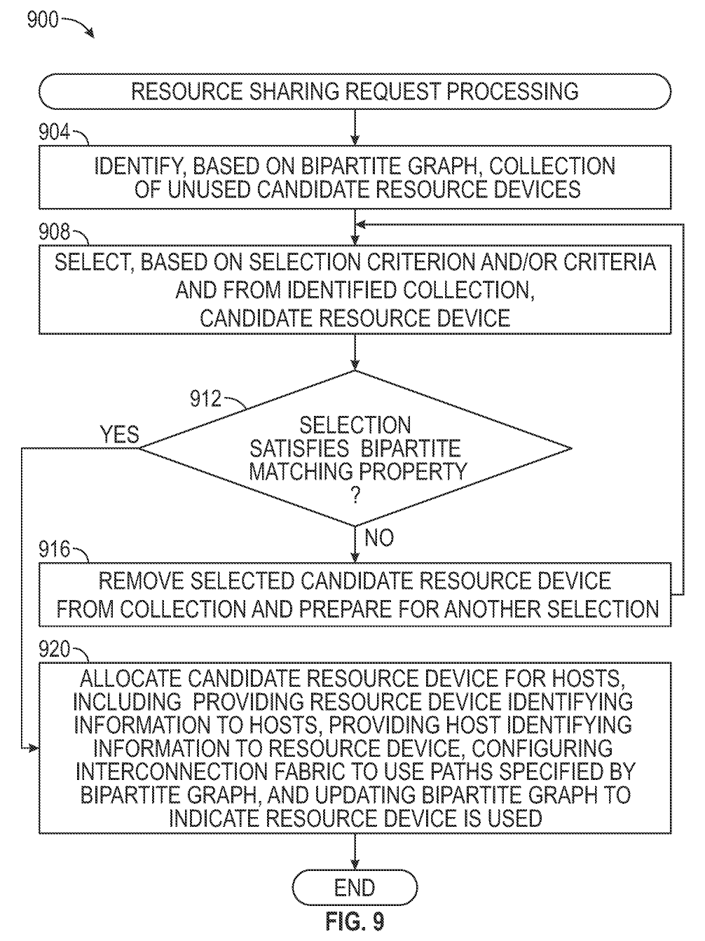

FIG. 9 is a flow diagram depicting a technique 900 used by a distributed fabric manager engine for purposes of processing a resource sharing request, in accordance with example implementations. The distributed fabric manager engine 190 of FIG. 1, the distributed fabric manager engine 290 of FIG. 2 and the distributed fabric manager engine 390 of FIG. 3 are examples of the distributed fabric manager engine. For this example, the resource sharing request is a request to allocate a shared resource device to multiple hosts.

Pursuant to block 904 of the technique 900, the distributed fabric manager engine identifies, based on a bipartite graph, a collection of unused candidate resource devices. Pursuant to block 908, the distributed fabric manager engine selects, based on a selection criterion or selection criteria and from the identified collection, a candidate resource device to be allocated. In an example, the selection criterion corresponds to the lowest latency for all of the available resource devices. In an example, the fabric manager engine, based on the bipartite graph, adds the path latencies for each unallocated resource device to derive a path latency summation, and the resource device having the lowest associated latency weight summation corresponds to the selected candidate resource device. In an example of another selection criterion, the distributed fabric manager engine excludes unallocated resource devices whose path latencies are not within a certain percentage of each other. In another example of a selection criterion, the distributed fabric manager engine selects an unallocated resource device having the lowest path latency.

The distributed fabric manager engine next considers whether the selection of the candidate resource device satisfies a bipartite matching property, as depicted in decision block 912. If the selection of the candidate resource device does not satisfy the bipartite matching property, then, pursuant to block 916, the distributed fabric manager engine removes the selected candidate resource device from the identified collection of unused candidate resource devices and prepares for another selection. In this manner, control returns to block 908, in which the distributed fabric manager selects another candidate resource device.

If, however, the distributed fabric manager engine determines (decision block 912) that the selection of the candidate resource device satisfies the bipartite matching property, then, the distributed fabric manager engine proceeds to allocate the candidate resource device for the hosts. As depicted in block 920, the allocation of the candidate resource device includes the distributed fabric manager engine providing resource device identifying information to the hosts and providing host identifying information to the resource device. Moreover, as also depicted in block 920, the allocation of the candidate resource device includes configuring the host-resource interconnection fabric to use paths specified by the bipartite graph and updating the bipartite graph to indicate that the resource device is now used, or allocated.

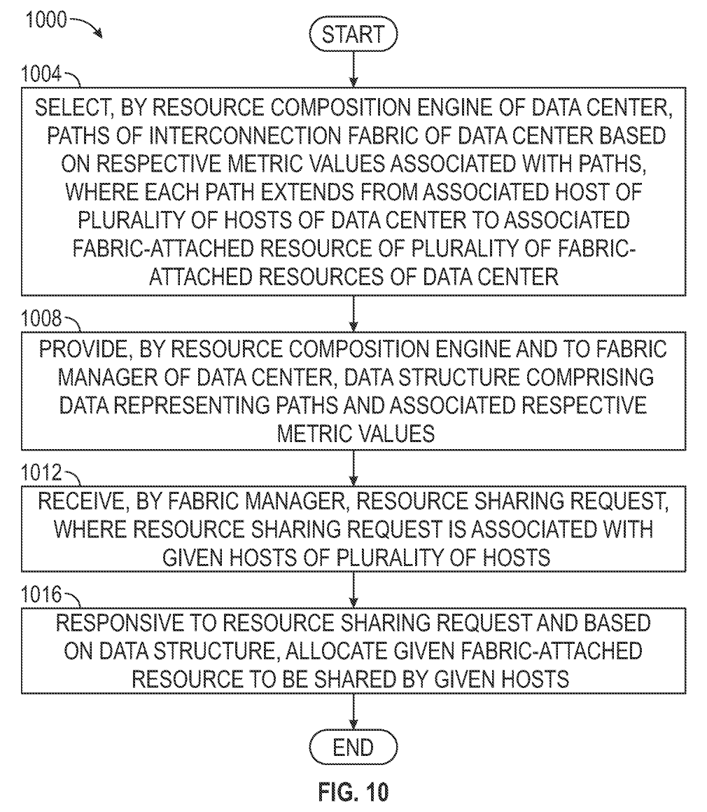

Referring to FIG. 10, in accordance with example implementations, a technique 1000 includes selecting (block 1004) by a resource composition engine of a data center, paths of an interconnection fabric of the data center based on respective metric values that are associated with the paths. In an example, the interconnection path is CXL fabric and complies with the Compute Express Link 3.1 Specification. In an example, the interconnection fabric includes fabric switches that are directly attached to hosts of the data center, and the interconnection fabric includes fabric switches that are directly attached to resource devices of the data center.

The resource devices may be virtual devices, physical devices or a combination of virtual and physical devices. The interconnection fabric may include fabric switches that connect host-attached fabric switches and resource device-attached switches. The interconnection fabric may use port-based routing. In an example, the resource composition engine may be hosted on a server of the data center. In example, the metric values are latency values. In an example the metric values include link latency values.

Each path extends from an associated host of a plurality of hosts of the data center to an associated fabric-attached resource of a plurality of fabric-attached resources of the data center. In an example a host is associated with a compute node. In an example a host is associated with a server or other processor-based device. In an example, the selected paths correspond to a single path selected from each host and resource device pair. In an example, the single paths are selected based on their respective associated latencies. In an example, a particular resource device may be reached by a particular host by multiple paths, and the corresponding single path is the path of the multiple paths having the lowest associated latency.

The technique 1000 includes providing (block 1008), by the resource composition engine and to a fabric manager of the data center, a data structure including data representing paths and the associated respective metric values. In an example, the data structure represents a bipartite graph. In an example, the bipartite graph includes host vertices corresponding to respective hosts, resource device vertices corresponding to respective resource device and edges connecting the host and resource device vertices. In an example, the edges correspond to minimum latency paths between respective host and resource device pairs. In an example, the fabric manager is a distributed fabric manager. In an example, the data structure includes data representing latency weights for respective edges. In an example, the data structure includes data representing identifiers for respective edges. In an example, the data structure includes data representing identifiers for respective hosts. In an example, the data structure includes data representing identifiers for respective resource devices.

Pursuant to block 1012 of the technique 1000, the fabric manager receives a resource sharing request. The resource sharing request is associated with given hosts of the plurality of hosts. In an example, the resource sharing request is an allocation request that is generated by a host workload. In another example, the resource sharing request is an allocation request generated by an application operating environment orchestrator.

Pursuant to block 1016, the technique 1000 includes, responsive to the resource sharing request and based on the data structure, allocating a given fabric-attached resource to be shared by the given hosts. In an example, allocating the given fabric-attached resource includes configuring the interconnection fabric to constrain traffic between the hosts and the given fabric-attached resource to specific paths of the interconnection fabric. In an example, the specific paths are indicated by the bipartite graph.

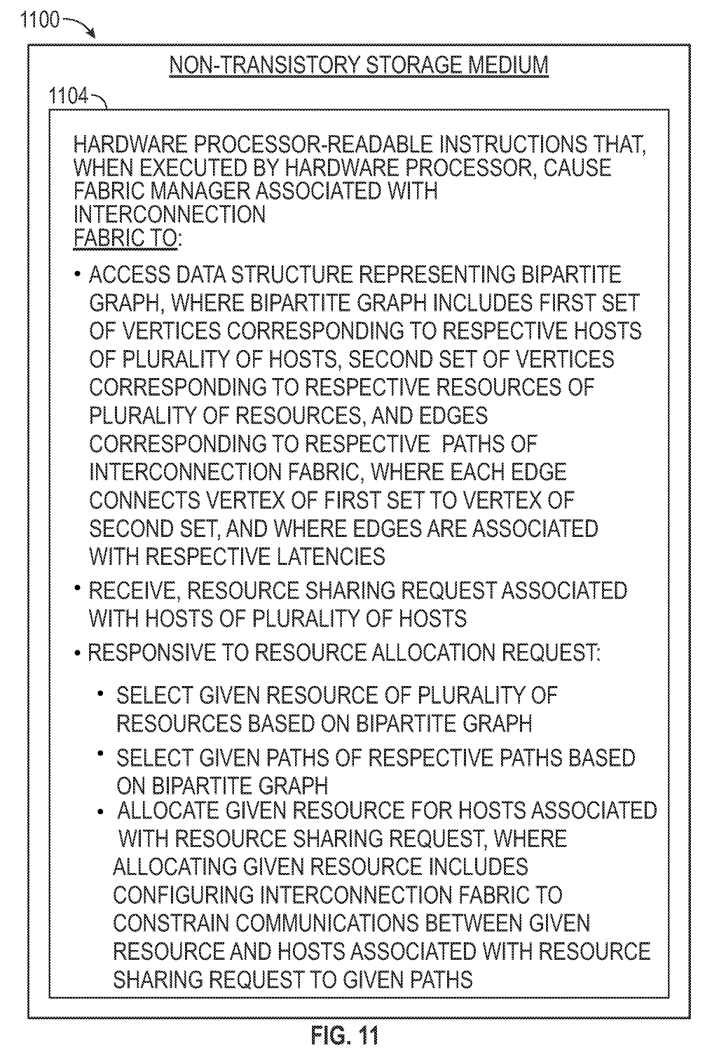

Referring to FIG. 11, in accordance with example implementations, a non-transitory storage medium 1100 stores hardware processor-readable instructions 1104. The instructions 1104, when executed by a hardware processor, cause a fabric manager that is associated with an interconnection fabric to access a data structure representing a bipartite graph. In an example, the non-transitory storage medium is a memory that is formed from a collection of semiconductor devices. In examples, the hardware processor includes one or multiple CPU cores.

In an example, the interconnection fabric is CXL fabric and complies with the Compute Express Link 3.1 Specification. In an example, the interconnection fabric includes fabric switches that are directly attached to hosts, and the interconnection fabric includes fabric switches that are directly attached to resource devices. In an example, the interconnection fabric is associated with a data center. In an example, the interconnection fabric includes fabric switches that are directly attached to hosts, and the interconnection fabric includes fabric switches that are directly attached to resource devices. The resource devices may be virtual devices, physical devices or a combination of virtual and physical devices. The interconnection fabric may include fabric switches that connect host-attached fabric switches and resource device-attached switches. The interconnection fabric may use port-based routing.

The bipartite graph includes a first set of vertices that correspond to respective hosts of a plurality of hosts and a second set of vertices that correspond to respective resources of a plurality of resources. The bipartite graph further includes edges that correspond to respective paths of the interconnection fabric. Each edge of the edges connects a vertex of the first set to a vertex of the second set. The edges are associated with respective latencies. In example, the bipartite graph has edge weights that correspond to the latencies.

The instructions 1104, when executed by the hardware processor, further cause the fabric manager to receive a resource sharing request associated with hosts of the plurality of hosts. In an example, the resource sharing request is an allocation request that is generated by a host workload. In another example, the resource sharing request is an allocation request generated by an application operating environment orchestrator.

The instructions 1104, when executed by the hardware processor, further cause the fabric manager to, responsive to the resource allocation request, select a given resource based on the bipartite graph and select given paths of the respective paths based on the bipartite graph. In an example, the hardware processor selects the given resource based on the path latencies that are represented by the bipartite graph.

The instructions 1104, when executed by the hardware processor, further cause the fabric manager to, responsive to the resource allocation request, allocate the given resource for the hosts associated with the resource sharing request. Allocating the given resource includes configuring the interconnection fabric to constrain communication between the given resource and the hosts associated with the resource sharing request to the given paths. In an example, allocating the given resource includes configuring port-based routing of the interconnection fabric. In an example, the allocation includes providing a resource identifier to the hosts. In an example, the allocation includes providing host identifiers to the given resource. In an example, allocating the given resource includes confirming that the allocation of the given resource satisfies a bipartite matching criterion.

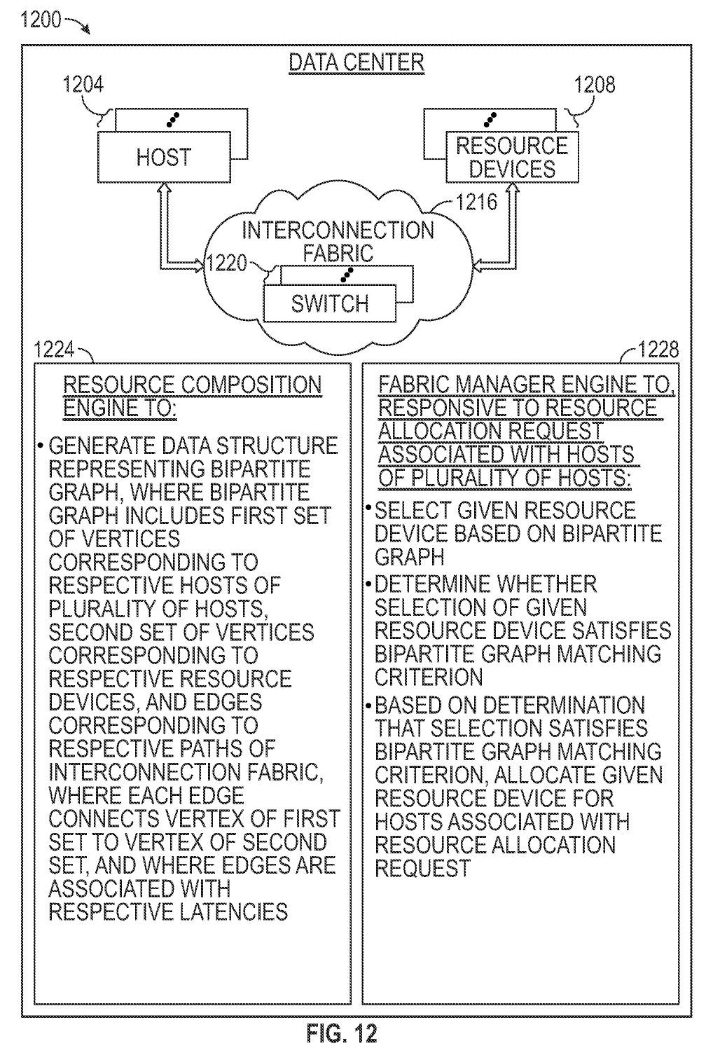

Referring to FIG. 12, in accordance with example implementations, a data center 1200 includes a plurality of hosts 1204; a plurality of resource devices 1208; and an interconnection fabric 1216 that includes switches 1220 to connect the plurality of hosts 1204 and the plurality of resource devices 1208. In an example, the data center 1200 is associated with a public cloud, a private cloud or a hybrid cloud. In an example, the hosts 1204 are associated with compute nodes. In an example, the hosts 1204 are associated with servers. In an example, the resource devices 1208 may be physical, virtual or a combination thereof.

In an example, the interconnection fabric is CXL fabric and complies with the Compute Express Link 3.1 Specification. In an example, the interconnection fabric includes fabric switches that are directly attached to hosts, and the interconnection fabric includes fabric switches that are directly attached to resource devices. In an example, the interconnection fabric includes fabric switches that interconnect host-attached fabric switches and resource device-attached fabric switches. In an example, the interconnection fabric includes ToR switches.

The data center 1200 further includes a resource composition engine 224 to generate a data structure that represents a bipartite graph. The bipartite graph includes a first set of vertices corresponding to respective hosts of the plurality of hosts. In an example, the data structure includes data representing identifiers of respective hosts. The bipartite graph further includes a second set of vertices corresponding to respective resource devices of the plurality of resource devices. In an example, the bipartite graph includes data representing identifiers of respective resource devices. In an example the resource devices are part of a resource pool. In another example, the resource devices are shared devices. In another example, the resource devices are memory devices. In another example, the resource devices are GPU devices.

The bipartite graph further includes edges that correspond to respective paths of the interconnection fabric 1216. Each edge of the edges connects a vertex of the first set to a vertex of the second set, and the edges are associated with respective latencies. In an example, the edges are assigned weights, with each weight representing a latency of an associated path. In an example, the data structure includes data representing, for each edge, an identifier of the associated path. In an example, the bipartite graph includes a single edge between a given host vertex and a given resource device vertex. In an example, there are multiple paths between the host corresponding to the given host vertex and the resource device corresponding to the given resource vertex, and the single edge represents the lowest latency path of the multiple paths.

The data center 1200 further includes a fabric manager engine 1228. The fabric manager engine 1228 to, responsive to a resource allocation request associated with hosts of the plurality of hosts 1204, selects a given resource device 1208 based on the bipartite graph. In an example, the fabric manager engine 1208 selects the given resource device 1208 based on the latencies. The fabric manager engine 1228 to further, responsive to the resource allocation request, determine whether selection of the given resource device 1208 satisfies a bipartite graph matching criterion. The fabric manager engine 1228 to further, responsive to the resource allocation request, allocate the given resource device 1208 for the hosts associated with the resource allocation request based on a determination that the selection satisfies the bipartite graph matching criterion. In an example, the allocation includes configuring the interconnection fabric 1216 to constrain communication between the given resource device 1208 and the hosts 1204 associated with the resource sharing request to the given paths. In an example, allocating the given resource device 1208 includes configuring port-based routing of the interconnection fabric 1216. In an example, the allocation includes providing a resource identifier to the hosts 1204. In an example, the allocation includes providing host identifiers to the given resource device 1208

In accordance with example implementations, selecting the paths includes, for a particular host of the plurality of hosts and a particular fabric-attached resource of the plurality of fabric-attached resources, identifying, by the resource composition engine, a collection of candidate paths over which the particular host can reach the particular fabric-attached resource. Selecting the paths further includes selecting, by the resource composition engine, a candidate path of the collection of candidate paths based on latencies associated with the candidate paths. Among the potential benefits, considering data center metric values when allocating fabric-attached resource devices provides predictable performances for host workloads when accessing the resource devices.

In accordance with example implementations, selecting the paths includes, for a particular host of the plurality of hosts and a particular fabric-attached resource of the plurality of fabric-attached resources, identifying, by the resource composition engine, a collection of candidate paths over which the particular host can reach the particular fabric-attached resource. Selecting the paths further includes selecting, by the resource composition engine, a candidate path of the collection of candidate paths based on a congestion associated a given candidate paths of the candidate paths. Among the potential benefits, considering data center metric values when allocating fabric-attached resource devices provides predictable performances for host workloads when accessing the resource devices.

In accordance with example implementations, the metric values include latencies. Allocating the given fabric-attached resource includes selecting, by the fabric manager, the given fabric-attached resource based on the latencies. Among the potential benefits, considering data center metric values when allocating fabric-attached resource devices provides predictable performances for host workloads when accessing the resource devices.

In accordance with example implementations, allocating the given fabric-attached resource further includes configuring, by the fabric manager, the interconnection fabric to route traffic between the given fabric-attached resource and the given hosts over the associated paths. Among the potential benefits, considering data center metric values when allocating fabric-attached resource devices provides predictable performances for host workloads when accessing the resource devices.

In accordance with example implementations, the data represents a bipartite graph. The bipartite graph includes vertices corresponding to respective hosts of the plurality of hosts. The bipartite graph includes vertices corresponding to respective fabric-attached resources of the plurality of resources. The bipartite graph comprises edges corresponding to respective paths of the paths of the interconnection fabric. Among the potential benefits, considering data center metric values when allocating fabric-attached resource devices provides predictable performances for host workloads when accessing the resource devices.

In accordance with example implementations, the data represents a bipartite graph. Allocating the given fabric-attached resource includes selecting, by the fabric manager, the given fabric-attached resource based on the data center metrics; determining, by the fabric manager, whether allocating the given fabric-attached resource satisfies a bipartite matching criterion; and determining to allocate the given fabric-attached resource responsive to a determination that allocation of the given fabric-attached resource satisfies the bipartite matching criterion. Among the potential benefits, considering data center metric values when allocating fabric-attached resource devices provides predictable performances for host workloads when accessing the resource devices.

In accordance with example implementations, the given fabric-attached resource is a virtual resource or a physical resource. Among the potential benefits, considering data center metric values when allocating fabric-attached resource devices provides predictable performances for host workloads when accessing the resource devices.

In accordance with example implementations, the resource composition engine updates the data structure responsive to changes in the metric values. Among the potential benefits, considering data center metric values when allocating fabric-attached resource devices provides predictable performances for host workloads when accessing the resource devices.

In accordance with example implementations, the resource composition engine updates the data structure responsive to an allocation or deallocation of a resource by the fabric manager engine. Among the potential benefits, considering data center metric values when allocating fabric-attached resource devices provides predictable performances for host workloads when accessing the resource devices.

In accordance with example implementations, the resource composition engine receives, from fabric switches of the interconnection fabric, information representing a topology of the data center. The resource composition engine identifies the paths based on the topology. Among the potential benefits, considering data center metric values when allocating fabric-attached resource devices provides predictable performances for host workloads when accessing the resource devices.

In accordance with example implementations, the data center metric values include path latencies. The resource composition engine receives, from fabric switches of the interconnection fabric, link latencies. The resource composition engine determines the path latencies based on the link latencies. Among the potential benefits, considering data center metric values when allocating fabric-attached resource devices provides predictable performances for host workloads when accessing the resource devices.

The detailed description set forth herein refers to the accompanying drawings. Wherever possible, the same reference numbers are used in the drawings and the foregoing description to refer to the same or similar parts. It is to be expressly understood, however, that the drawings are for the purpose of illustration and description only. While several examples are described in this document, modifications, adaptations, and other implementations are possible. Accordingly, the detailed description does not limit the disclosed examples. Instead, the proper scope of the disclosed examples may be defined by the appended claims.

The terminology used herein is for the purpose of describing particular examples only and is not intended to be limiting. As used herein, the singular forms "a," "an," and "the" are intended to include the plural forms as well, unless the context clearly indicates otherwise. The term "plurality," as used herein, is defined as two or more than two. The term "another," as used herein, is defined as at least a second or more. The term "connected," as used herein, is defined as connected, whether directly without any intervening elements or indirectly with at least one intervening element, unless otherwise indicated. Two elements can be coupled mechanically, electrically, or communicatively linked through a communication channel, pathway, network, or system. The term "and/or" as used herein refers to and encompasses any and all possible combinations of the associated listed items. It will also be understood that, although the terms first, second, third, etc. may be used herein to describe various elements, these elements should not be limited by these terms, as these terms are only used to distinguish one element from another unless stated otherwise or the context indicates otherwise. As used herein, the term "includes" means includes but not limited to, the term "including" means including but not limited to. The term "based on" means based at least in part on.

While the present disclosure has been described with respect to a limited number of implementations, those skilled in the art, having the benefit of this disclosure, will appreciate numerous modifications and variations therefrom. It is intended that the appended claims cover all such modifications and variations.

What is claimed is:

1. A method comprising:
selecting, by a resource composition engine of a data center, paths of an interconnection fabric of the data center based on respective metric values associated with the paths, wherein each path extends from an associated host of a plurality of hosts of the data center to an associated fabric-attached resource of a plurality of fabric-attached resources of the data center;
providing, by the resource composition engine and to a fabric manager of the data center, a data structure comprising data representing the paths and the associated respective metric values;
receiving, by the fabric manager, a resource sharing request, wherein the resource sharing request is associated with given hosts of the plurality of hosts; and
responsive to the resource sharing request and based on the data structure, allocating a given fabric-attached resource of the plurality of fabric-attached resources to be shared by the given hosts.

2. The method of claim 1, wherein selecting the paths comprises:
for a particular host of the plurality of hosts and a particular fabric-attached resource of the plurality of fabric-attached resources, identifying, by the resource composition engine, a collection of candidate paths over which the particular host can reach the particular fabric-attached resource; and
selecting, by the resource composition engine, a candidate path of the collection of candidate paths based on latencies associated with the candidate paths.

3. The method of claim 1, wherein selecting the paths comprises:
for a particular host of the plurality of hosts and a particular fabric-attached resource of the plurality of fabric-attached resources, identifying, by the resource composition engine, a collection of candidate paths over which the particular host can reach the particular fabric-attached resource; and
selecting, by the resource composition engine, a candidate path of the collection of candidate paths based on a congestion associated a given candidate paths of the candidate paths.

4. The method of claim 1, wherein:
the metric values comprise latencies; and
allocating the given fabric-attached resource comprises selecting, by the fabric manager, the given fabric-attached resource based on the latencies.

5. The method of claim 1, wherein allocating the given fabric-attached resource further comprises:
configuring, by the fabric manager, the interconnection fabric to route traffic between the given fabric-attached resource and the given hosts over the associated paths.

6. The method of claim 1, wherein:
the data represents a bipartite graph;
the bipartite graph comprises vertices corresponding to respective hosts of the plurality of hosts;
the bipartite graph comprises vertices corresponding to respective fabric-attached resources of the plurality of resources; and
the bipartite graph comprises edges corresponding to respective paths of the paths of the interconnection fabric.

7. The method of claim 1, wherein:
the data represents a bipartite graph; and
allocating the given fabric-attached resource comprises:
selecting, by the fabric manager, the given fabric-attached resource based on the data center metrics;
determining, by the fabric manager, whether allocating the given fabric-attached resource satisfies a bipartite matching criterion; and
determining to allocate the given fabric-attached resource responsive to a determination that allocation of the given fabric-attached resource satisfies the bipartite matching criterion.

8. The method of claim 7, wherein the given fabric-attached resource comprises a virtual resource or a physical resource.

9. The method of claim 1, further comprising updating, by the resource composition engine, the data structure responsive to changes in the metric values.

10. The method of claim 1, further comprising updating, by the resource composition engine, the data structure responsive to an allocation or deallocation of a resource by the fabric manager engine.

11. The method of claim 1, further comprising:
receiving, by the resource composition engine and from fabric switches of the interconnection fabric, information representing a topology of the data center;
identifying, by the resource composition engine, the paths based on the topology.

12. The method of claim 1, wherein the data center metric values comprise path latencies, the method further comprises:
receiving, by the resource composition engine and from fabric switches of the interconnection fabric, link latencies; and
determining, by the resource composition engine, the path latencies based on the link latencies.

13. A non-transitory storage medium storing hardware processor-readable instructions that, when executed by a hardware processor, cause a fabric manager associated with an interconnection fabric to:
access a data structure representing a bipartite graph, wherein the bipartite graph comprises a first set of vertices corresponding to respective hosts of a plurality of hosts, a second set of vertices corresponding to respective resources of a plurality of resources, and edges corresponding to respective paths of the interconnection fabric, wherein each edge of the edges connects a vertex of the first set to a vertex of the second set, and wherein the edges are associated with respective latencies;
receive, a resource sharing request associated with hosts of the plurality of hosts; and
responsive to the resource allocation request:
select a given resource of the plurality of resources based on the bipartite graph;
select given paths of the respective paths based on the bipartite graph; and
allocate the given resource for the hosts associated with the resource sharing request, wherein allocating the given resource comprises configuring the interconnection fabric to constrain communications between the given resource and the hosts associated with the resource sharing request to the given paths.

14. The storage medium of claim 13, wherein the instructions, when executed by the hardware processor, further cause the fabric manager to:
identify a subset of the second set of vertices corresponding to respective unallocated resources of the plurality of resources;
the unallocated resources include the given resource;
identify a subset of the edges connected to the vertices of the second set of vertices;
the subset of edges comprises the given edges;
select the given resource based on the latencies associated with the edges of the subset.

15. The storage medium of claim 13, wherein the instructions, when executed by the hardware processor, further cause the fabric manager to:
combine latencies associated with edges of the subset of the edges connected to the given resource; and
select the given resource responsive to the combination of the latencies.

16. A data center comprising:
a plurality of hosts;
a plurality of resource devices;
an interconnection fabric comprising switches to connect the plurality of hosts and the plurality of resource devices;
a resource composition engine to generate a data structure representing a bipartite graph, wherein the bipartite graph comprises a first set of vertices corresponding to respective hosts of the plurality of hosts, a second set of vertices corresponding to respective resource devices of the plurality of resource devices, and edges corresponding to respective paths of the interconnection fabric, wherein each edge of the edges connects a vertex of the first set to a vertex of the second set, and wherein the edges are associated with respective latencies; and
a fabric manager engine to, responsive to a resource allocation request associated with hosts of the plurality of hosts:
select a given resource device of the plurality of resource devices based on the bipartite graph;
determine whether selection of the given resource device satisfies a bipartite graph matching criterion; and
based on a determination that the selection satisfies the bipartite graph matching criterion, allocate the given resource device for the hosts associated with the resource allocation request.

17. The data center of claim 16, wherein the fabric manager engine to further select the given resource based on latencies associated with edges connected to the given resource device.

18. The data center of claim 16, wherein the fabric manager engine to further:
responsive to the resource allocation request, select, based on the bipartite graph, a second resource device of the plurality of resource devices other than the given resource device;
determine that selection of the second resource device does not satisfy the bipartite graph matching criterion; and
based on the determination that the selection of the second resource devices does not satisfy the bipartite graph matching criterion, select the given resource device.

19. The data center of claim 16, wherein the fabric manager engine to further configure port-based routing of the interconnection fabric to allocate the given resource device for the hosts.

20. The data center of claim 15, wherein the interconnection fabric comprises top-of-the-rack switches.
.
